(19) United States
(12) Patent Application Publication
(10) Pub. No.: US 2013/0237301 A1
(43) Pub. Date: Sep. 12, 2013

(54) MULTI-ACTION POKER GAME AND METHOD OF CONDUCTING MULTIPLE HANDS SUBSTANTIALLY SIMULTANEOUSLY

(71) Applicant: PAC GAMING LLC, Dallas, TX (US)

(72) Inventor: Timothy M. Frazin, Dallas, TX (US)

(73) Assignee: PAC GAMING LLC, Dallas, TX (US)

(21) Appl. No.: 13/790,876

(22) Filed: Mar. 8, 2013

Related U.S. Application Data
(63) Continuation-in-part of application No. 13/416,250, filed on Mar. 9, 2012.

(51) Int. Cl. A63F 1/00; G07F 17/32

(52) U.S. Cl. CPC A63F 1/00; G07F 17/3293
USPC 463/13; 273/292

(57) ABSTRACT

Simultaneous poker hands played on an elliptical, table incorporating two dealer stations with each dealer station including one or more of the following: automatic shuffler; chip rack and chips; poker cards; and drop box. Using the table facilitates the play of a game comprising broadly: positioning two dealers about a table at two independent dealer stations and utilizing said two dealers to deal independent poker hands substantially simultaneously; and providing players with two distinctive chip sets and sets of cards to play said independent poker hands substantially simultaneously. A pair of distinct dealer buttons provides means for play of the two poker games to be managed independently. In other versions, a single chip set may be used; the table may depict separate betting areas; and/or one of the multiple dealers may be an electronic system. Commonly colored dealer buttons, betting areas and cards may maintain the independence of the two poker games.

### CROSS-REFERENCES

This application is a continuation-in-part of U.S. patent application Ser. No. 13/416,250 filed Mar. 9, 2012 which is incorporated herein for all purposes. This application is related to U.S. patent application Ser. Nos. 13/416,347 and 13/454,001 filed Mar. 9, 2012 and Apr. 23, 2012, respectively, which are both incorporated herein for all purposes. This application is related to co-pending U.S. patent application Ser. Nos. ______ and ______, filed ______ and ______, respectively, which are both incorporated herein for all purposes.

### FIELD OF THE INVENTION

The embodiments of the present invention relate to a poker game utilizing a table configured to accommodate two dealers for conducting a multi-action poker game using two decks of cards whereby independent hands are being played substantially simultaneously.

### BACKGROUND

The popularity of poker has exploded over the last ten years. As a result, purses and tournament fields have increased dramatically along with the desire to play cash games. Despite its popularity, poker can be tedious during down time or cold runs of cards, especially for players craving action. The down time or cold run of cards can last for ten or more hands consecutively over a 15-20 minute period of time or more. Also, for younger players raised on fast pasted video games, traditional poker does not provide enough sensory stimulation to maximize engagement.

Thus, it would be advantageous to develop a new poker game to reduce the down time for players and increase playing action, thereby maintaining a high level of interest.

### SUMMARY

The embodiments of the present invention are directed to a multi-action poker game played on a poker table incorporating two dealer stations with each dealer station including one or more of the following: automatic card shuffler; chip rack and chips; poker cards; and drop box, as described in co-pending U.S. patent application Ser. No. 13/416,347, and which is incorporated herein for all purposes along with any continuation applications. Using the poker table facilitates the play of a poker game comprising broadly: positioning two dealers about a poker table at two independent dealer stations, each dealer station including one or more of the following: (i) automatic card shuffler; (ii) chip rack and chips; (iii) poker cards; and (iv) drop box; utilizing said two dealers to deal independent poker hands substantially simultaneously; and providing poker players with two distinctive poker chip sets to play said independent poker hands substantially simultaneously.

Another embodiment includes broadly: positioning two dealers about a poker table at two independent dealer stations, each dealer station including one or more of the following: (i) automatic card shuffler; (ii) chip rack and chips; (iii) poker cards; and (iv) drop box; utilizing said two dealers to deal independent poker hands substantially simultaneously; providing poker players with two distinctive poker chip sets to play said independent poker hands substantially simultaneously and providing each dealer with a distinguishable dealer button.

Another embodiment includes a method of conducting a poker game comprising: utilizing two dealers at a poker table to deal and manage independent poker hands substantially simultaneously, said two dealers using independent and distinguishable: (i) poker cards; (ii) poker chips and/or (iii) dealer buttons.

In another embodiment, a single set of chips may be used to play the independent poker hands. For example, a limit Texas Hold'em game may be played with a single set of chips. In such instances, the poker table may include different betting areas to maintain the distinction between bets on the independent poker hands.

Another embodiment includes poker game system comprising: a poker table having two independent dealer stations; two independent and distinguishable decks of cards; two independent and distinguishable chip sets; and wherein a dealer at each dealer station deals and manages an independent hand substantially simultaneously using said two independent and distinguishable decks of cards and said two independent and distinguishable chip sets.

In another embodiment, one dealer may be a live person and one dealer may be electronic and driven by a processor. In another embodiment, the poker table having two independent dealer stations may be convertible to a dealer table with a single dealer table.

Other variations, embodiments and features of the present invention will become evident from the following detailed description, drawings and claims.

### BRIEF DESCRIPTION OF THE DRAWINGS

FIG. 1 illustrates an overhead view of a poker table of the type to facilitate the play of a poker game according to the embodiments of the present invention;

FIG. 2 illustrates an overhead view of the poker table of FIG. 1 with distinct common card areas proximate the dealer stations according to the embodiments of the present invention;

FIGS. 3a and 3b illustrate flow charts detailing alternative methods of conducting a poker game according to the embodiments of the present invention;

FIGS. 4a and 4b illustrate first and second poker cards from independent decks of poker cards according to the embodiments of the present invention;

FIG. 5 illustrates an overhead view of a poker table with two distinct dealer buttons according to the embodiments of the present invention;

FIG. 6 illustrates an overhead view of player position with distinct betting areas suitable for a single chip set embodiment according to the embodiments of the present invention; and

FIG. 7 illustrates an overhead view of a poker table with a single live dealer station and player displays facilitating an electronic dealer according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The embodiments of the present invention utilize conventional decks of 52 cards comprising suits of spades, hearts, diamonds and clubs and 13 ranks comprising 2-10, Jacks, Queens, Kings and Aces. Jokers may also be used. It is conceivable that other card types and combinations may be used as well.

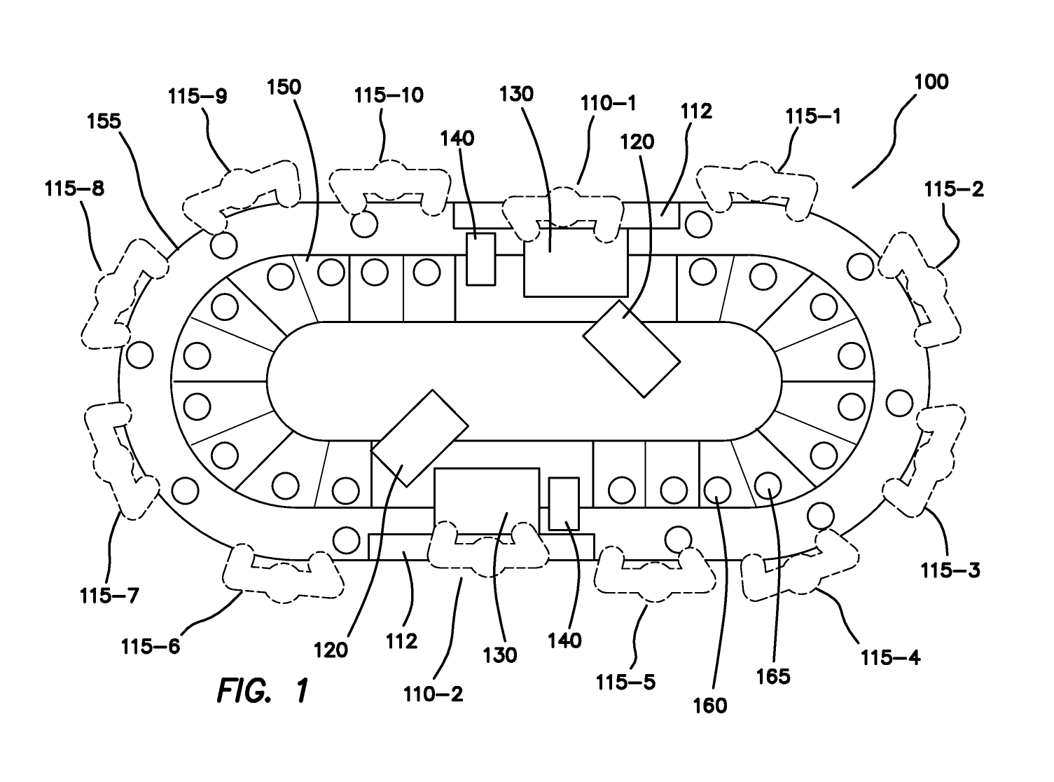

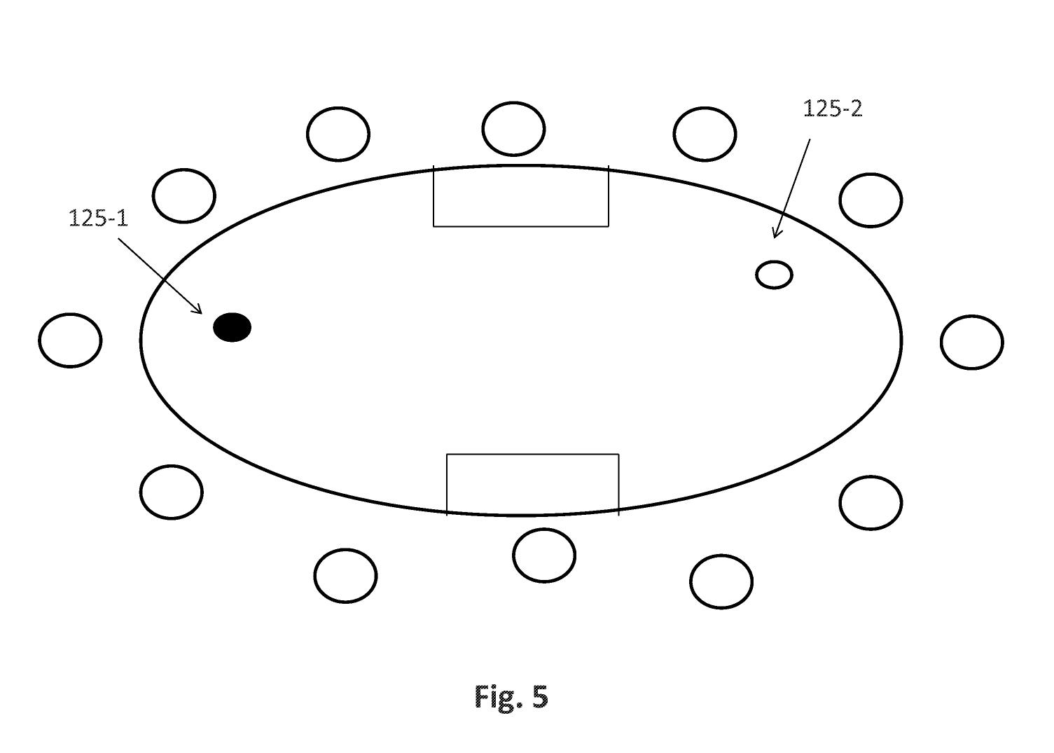

FIG. 1 shows an overhead view of a poker table 100 of the type which may be used to facilitate a poker game according to the embodiments of the present invention. As shown, the poker table 100 is elliptical in shape but those skilled in the art will recognize that other shapes are possible (e.g., circular and square). The poker table 100 incorporates a pair of dealer stations 110-1 and 110-2 and accommodates ten players at ten player stations 115-1 through 115-10. More or less players may be accommodated by the poker table 100 or any other table. Depending on the embodiment, each dealer station 110-1 and 110-2 may include an automatic card shuffler 120, chip rack 130 and drop box 140. To allow players and the dealers to maintain the independence of the poker hands, each dealer may be provided with a distinguishable dealer button 125-1, 125-2 as shown in FIG. 5. The dealer buttons 125-1, 125-2 may be colored, shaped or dimensioned differently, or otherwise made distinguishable from one another. Thus, each independent poker hand may have a dealer button positioned at the same or different player position. The order of dealing the cards and blind positions for each independent poker hand are determined in a conventional fashion by the position of the dealer buttons 125-1, 125-2.

In one embodiment, as shown in FIG. 1, the dealer stations 110-1 and 110-2 are positioned oppositely on long sides of the poker table 100 in an offset relationship. Other dealer station positions are possible without departing from the scope and spirit of the embodiments of the present invention. Each dealer station 110-1 and 110-2 is defined by a cut-out area 112. Two dealer stations 110-1 and 110-2 permit each dealer to deal poker hands which are played substantially simultaneously on the poker table 100. While two dealer stations 110-1 and 110-2 are shown, more than two dealer stations are conceivable. A padded railing 155 circumscribes the poker table 100 in a conventional fashion. The poker table 100 may be designed, as described in co-pending U.S. patent application Ser. No. 13/416,347, such that one of the two cut-out areas 112 may be covered to render the poker table 100 suitable for a single-handed traditional poker game.

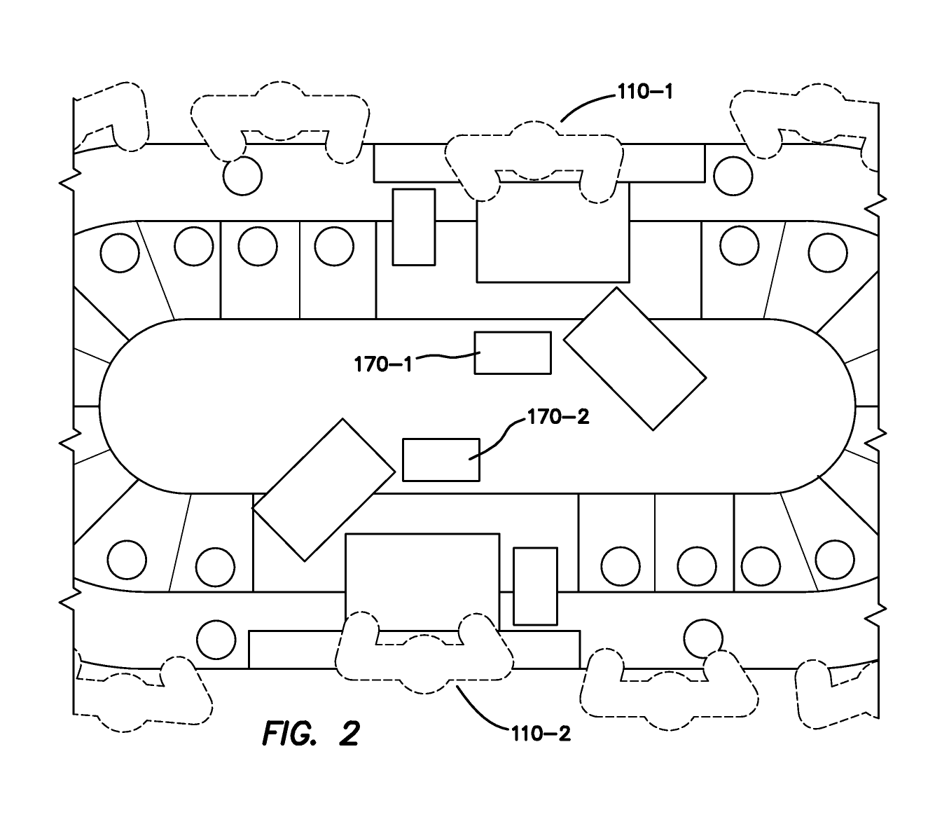

A poker table layout 150 depicts two chip areas 160, 165 at each player station 115-1 through 115-10. The two chip areas 160, 165 may be colored differently or otherwise distinguished from one another to allow players to segregate chips from the independent poker hands. FIG. 2 shows the poker table 100 of FIG. 1 with distinct common card areas 170-1 and 170-2 proximate the dealer stations 110-1 and 110-2, respectively. The common card areas 170-1 and 170-2 may be defined by different colored borders or otherwise distinguished.

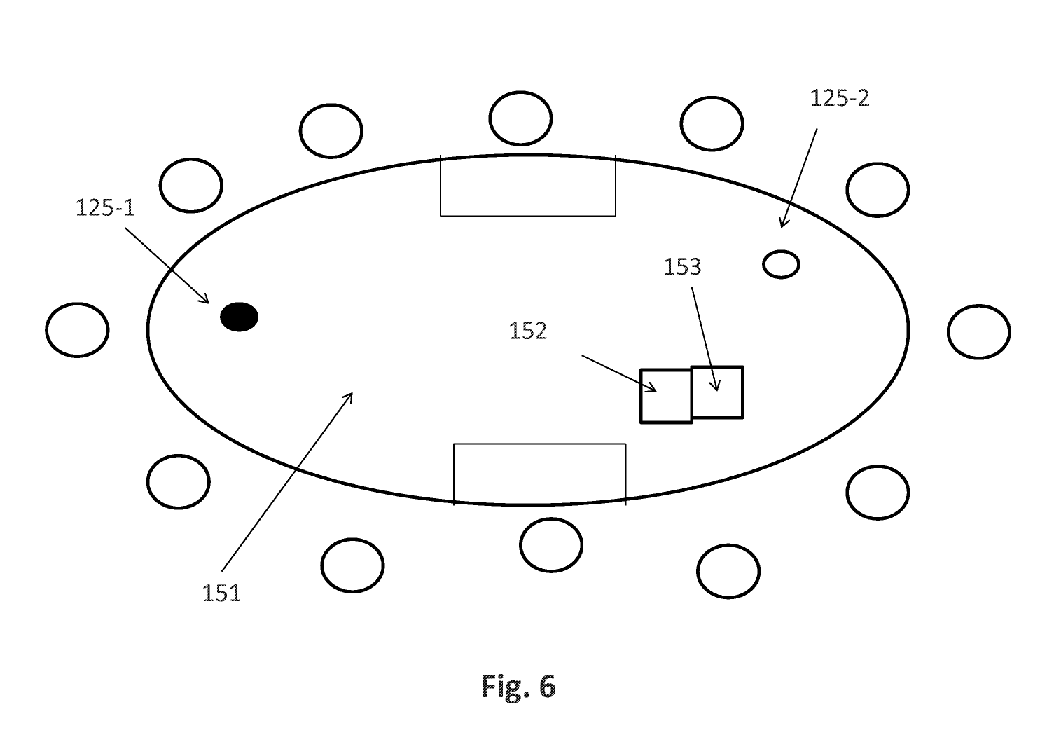

In another embodiment, as shown in FIG. 6, a poker table layout 151 may also depict distinct betting areas 152, 153 for each player position (although only one set of betting areas 152, 153 is shown for one of the player position) suitable for independent poker hands played from a single chip set. The distinct betting areas 152, 153 at each player position allow two independent poker hands to be played with a single set of chips (i.e., no need to use two distinguishable chip sets). The distinct betting areas 152, 153 allow dealers to know which pot into which chips should be placed. For example, limit poker has pre-established betting limits which are conducive to a single set of chips. To maintain a easy-to-follow distinction between play of the two poker games (especially with a single chip stack), the cards, button, and betting areas from a first poker game may take on a first identical color (red) while the cards, button and betting areas from a second poker game may take on a second identical color (blue).

As detailed above, the poker table 100 facilitates the play of independent poker hands substantially simultaneously at the same table. The play of independent poker hands substantially simultaneously satisfies the need for “action” by many players, especially younger players seeking an increased pace and level of stimulation. In addition, the house benefits from additional poker table revenue (i.e., the house collects more in rakes and/or entry fees), which may be greater than twice normal poker table revenues, without raising overhead significantly. Indeed, the only true increase in overhead relates to the fixed costs associated with acquiring the novel poker tables and ongoing expense of an additional dealer both of which are quickly minimized by the increase in revenue.

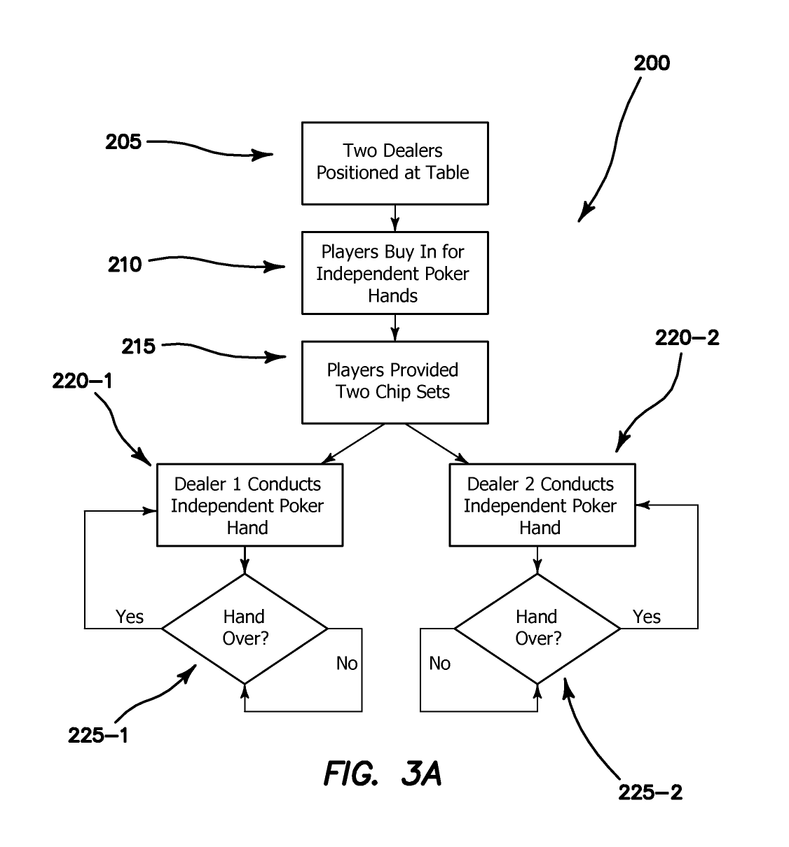

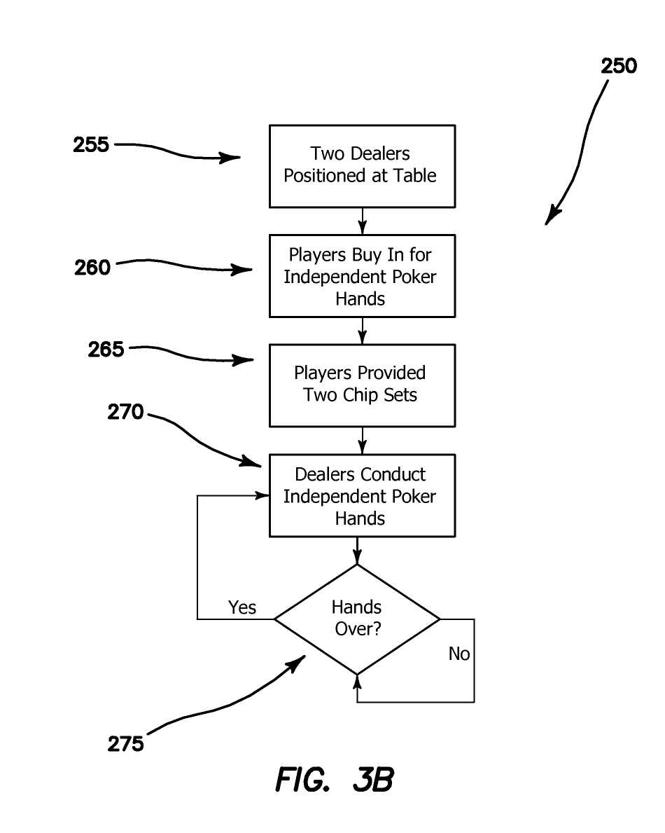

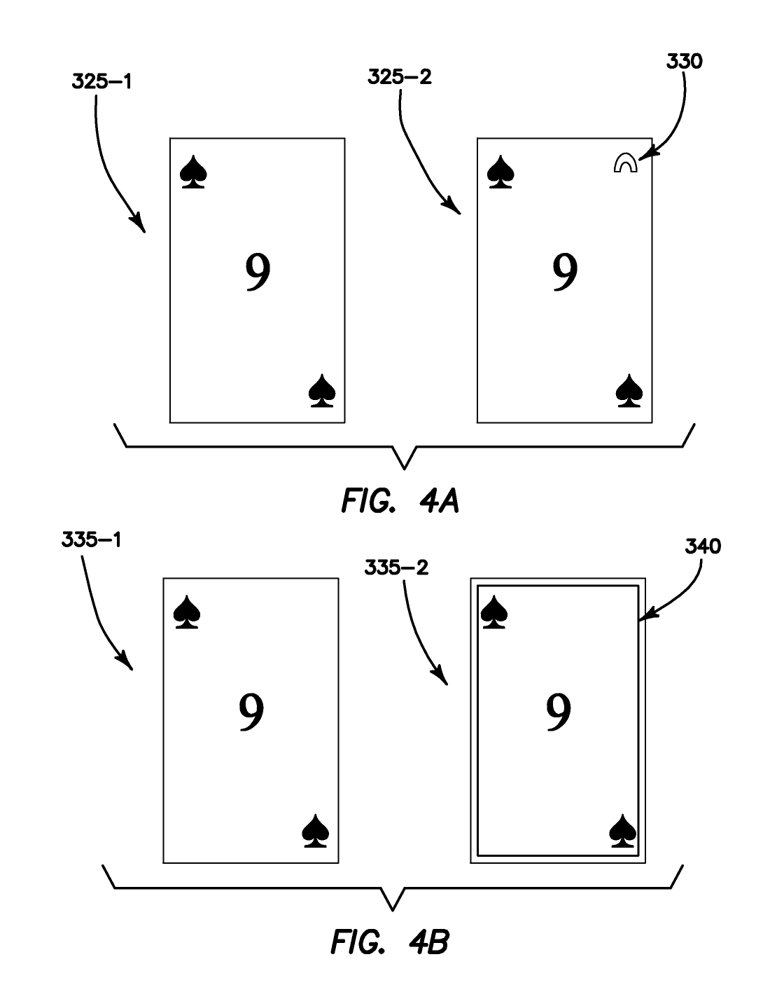

FIG. 3a shows a flow chart 200 detailing a first method of conducting the poker game according to the embodiments of the present invention. At 205, two dealers are positioned at respective, independent dealer stations. At 210, players buy in to play the independent hands of poker. At 215, players are provided with distinctive poker chips for each hand. For example, a first poker hand may use blue, red, green and black chips while the second poker hand may use yellow, orange, pink and purple chips. Other chip distinctions include different cross-hatch patterns, color combinations, and sizes. Well-known RFID technology may also be used to prevent inadvertent or purposeful co-mingling of the different poker chips. Lighted chips and unlighted chips may also be used to distinguish between the independent poker hands as well. The poker cards may also be distinguished to keep them from inadvertent or purposeful co-mingling. In one embodiment, the backs of the two independent decks of poker cards have different colors and/or patterns. However, as the front of the poker cards are often being shown, it may also be desirable to distinguish the front of the poker cards from each deck of poker cards. This may be accomplished subtly using a number, color tint, symbol, pattern or other indication on the face of the poker cards from one of the decks of poker cards. FIG. 4a shows a first poker card 325-1 from a first deck of poker cards and the same poker card 325-2 from a second deck of poker cards. The symbol 330 in the upper right hand corner is on each card 325-2 of the second deck of poker cards. Alternatively, one deck of poker cards may have a border on the face of the poker cards while the faces of the poker cards from the other deck do not. FIG. 4b shows a first poker card 335-1 from a first deck of poker cards and the same poker card 335-2 from a second deck of poker cards with the border 340. At 220-1, 220-1, the dealers each conduct their independent poker hands using the independent (i) automatic card shufflers; (ii) chip racks and chips; (iii) poker cards; and/or (iv) drop boxes. Accordingly, each dealer manages wagers and a game pot from each set of independent poker hands and maintains a separation of the chips and pot from the other poker hand set being played substantially simultaneously. At 225-1, 225-2, it is determined if either poker hand has ended, if so, the chart loops back to 225-1, 225-2, respectively, for the dealer of the ended hand to deal another hand. Thus, players are playing independent poker hands substantially simultaneously as each dealer deals his or her poker hands without concern for the progress of the other poker hand—that is, each poker hand in literally independent and each dealer may deal a varied number of hands over a gaming session.

FIG. 3b shows a flow chart 250 detailing a second method of conducting a poker game according to the embodiments of the present invention. At 255, two dealers are positioned at respective, independent dealer stations. At 260, players buy in to play the independent hands of poker. At 265, players are provided with distinctive poker chips for each hand. At 270, the dealers each conduct their independent poker hands using the independent (i) automatic card shufflers; (ii) chip racks and chips; (iii) poker cards; and/or (iv) drop boxes. At 275, it is determined if both hands are over. If so, the chart loops back to 270 for the dealers to each deal the next hand at the same time. In this alternative embodiment, the dealers both finish their respective poker hand before either dealer deals the next hand. Thus, each dealer deals the same number of hands over a gaming session such that again the players are playing poker hands substantially simultaneously.

In flow charts 200, 250, the dealers also use the dealer buttons 125-1, 125-2 in a conventional fashion to determine the order of dealing the cards and the blind player positions.

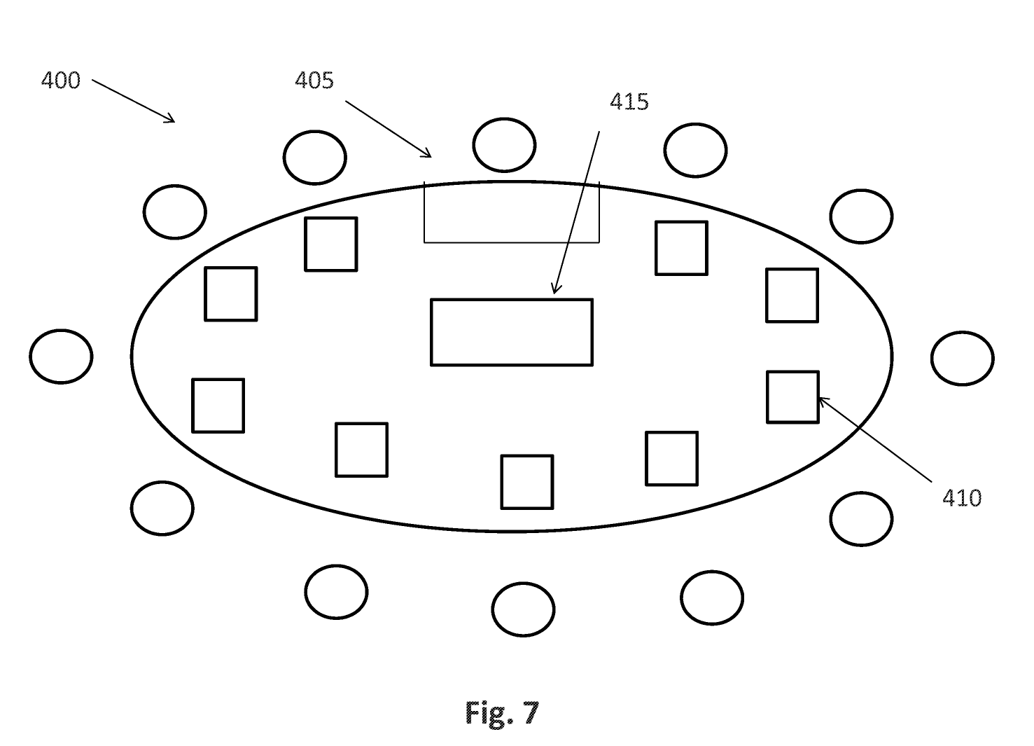

In another embodiment, two simultaneous poker hands are managed by a live dealer, located at a live dealer station 400, and an electronic dealer, managed by a processor (not shown). In such an embodiment, as shown in FIG. 7, each player position includes a display 405, and a common display 410 may be used to display common cards. A processor including, or in communication with, a random number generator controls play of one game of poker facilitated by said player displays 405 and common card display 410. User interfaces incorporated into the displays 405 are configured to allow players to make poker game decisions, including making wagers, folding, raising and calling. Electronic poker tables are known in the art and need not be explained in minute detail herein. One such electronic poker table is promoted and sold under the name PokerPro by PokerTek, Inc., headquartered in North Carolina. As set forth above, relative to two live dealers, the live dealer and electronic dealer/system conduct two poker games substantially simultaneously at the poker table. If the two poker games are configured to start together, the live dealer may trigger the start of the electronic dealer via a game interface integrated into the poker table or via a remote control unit. If the two poker games are configured to continue independently of one another, the live dealer need only focus on the live poker game while the electronic dealer/system handles the electronic poker game.

The simultaneous poker hands may be directed to cash games or tournaments. Indeed, the simultaneous poker hands may lend themselves to interesting tournament scenarios which incorporate success of players in both poker hands substantially simultaneously. Any number of poker hands, including Texas Hold'em, Omaha and Seven Card Stud, may be played substantially simultaneously according to the embodiments of the present invention. Indeed, different two poker hands (e.g., Texas Holde'em and Omaha) may be played substantially simultaneously, and the direction of play may be varied.

Although the invention has been described in detail with reference to several embodiments, additional variations and modifications exist within the scope and spirit of the invention as described and defined in the following claims.

I claim:

1. A method of conducting a poker game comprising:
positioning two dealers about a poker table at two independent dealer stations, each dealer station including one or more of the following:
(i) automatic card shuffler;
(ii) chip rack and chips;
(iii) poker cards; and
(iv) drop box; and
utilizing said two dealers to deal independent poker hands substantially simultaneously from two independent decks of cards including: (i) positioning independent, distinguishable dealer buttons; (ii) creating two independent poker pots from collected bets; and (iii) paying winners of each independent poker hand one of said two independent poker pots.

2. The method of claim 1 further comprising utilizing a single set of chips.

3. The method of claim 1 further comprising utilizing two sets of distinguishable chips.

4. The method of claim 1 further comprising utilizing two sets of distinguishable cards.

5. The method of claim 1 further comprising utilizing cards, dealer button and betting areas of a first identical color for a first poker game and cards, dealer button and betting areas of a second identical color for a second poker game.

6. A method of conducting a poker game comprising:
positioning two dealers about a poker table at two independent dealer stations, each dealer station including one or more of the following:
(i) automatic card shuffler;
(ii) chip rack and chips;
(iii) poker cards; and
(iv) drop box;
instructing each dealer to position independent, distinguishable dealer buttons;
instructing each dealer to deal cards from independent decks of cards substantially simultaneously in a manner representative of the hand being played such that each player has two sets of cards attributable to independent poker hands;
instructing dealers to collect bets from independent betting areas to form two independent pots; and
instructing dealers to pay winners of each independent poker hand one of said two independent poker pots.

7. The method of claim 6 further comprising utilizing a single set of chips.

8. The method of claim 6 further comprising utilizing two sets of distinguishable chips.

9. The method of conducting a poker game according to claim 6 further comprising utilizing two decks of distinguishable cards.

10. The method of claim 6 further comprising utilizing cards, dealer button and betting areas of a first identical color for a first poker game and cards, dealer button and betting areas of a second identical color for a second poker game.

11. A method of conducting a poker game comprising:
utilizing two dealers at a poker table to deal and manage independent poker hands substantially simultaneously by: (i) positioning independent, distinguishable dealer buttons; (ii) dealing each player multiple sets of cards; (iii) creating two independent poker pots from collected bets; and (iii) paying winners of each independent poker hand one of said two independent poker pots.

12. The method of claim 11 further comprising utilizing a single set of chips.

13. The method of claim 11 further comprising utilizing two sets of distinguishable chips.

14. The method of conducting a poker game according to claim 11 further comprising utilizing two decks of distinguishable cards.

15. The method of claim 11 further comprising utilizing cards, dealer button and betting areas of a first identical color for a first poker game and cards, dealer button and betting areas of a second identical color for a second poker game.

16. A poker game system comprising:
a poker table having a live dealer and electronic system;
wherein said live dealer and said electronic system each manages an independent poker hand substantially simultaneously;
utilizing said live dealer to: (i) position a physical dealer button; (ii) deal each player a physical set of cards; (iii) create a physical poker pot from collected bets; and (iii) pay a winner of the poker hand said physical pot; and
utilizing said electronic system to: (i) position a simulated dealer button; (ii) display a simulated set of cards on each player display; (iii) create an electronic pot from electronic bets; and (iii) pay a winner of the poker hand said electronic pot.

17. The poker game system of claim 16 further comprising utilizing said electronic system to display common cards on a poker table display separate from each of said player displays.
